(19) United States
(12) Patent Application Publication
(10) Pub. No.: US 2026/0313385 A1
(43) Pub. Date: Oct. 8, 2026

(54) DEVICE, METHOD AND MEDIUM IN SPECTRUM SHARING SYSTEM

(71) Applicant: SONY GROUP CORPORATION, TOKYO (JP)

(72) Inventors: KEXIN CHEN, TOKYO (JP); WEI WANG, TOKYO (JP); SHUO WANG, TOKYO (JP); CHEN SUN, TOKYO (JP)

(21) Appl. No.: 19/483,141

(22) PCT Filed: Aug. 28, 2023
(86) PCT No.: PCT/CN2023/115161

§ 371 Date: Nov. 10, 2025

(30) Foreign Application Priority Data
May 19, 2023 (CN) 202310572430.X

(51) Int. Cl. H04W 16/14; G06Q 40/04; H04L 41/16; H04L 43/10

(52) U.S. Cl. CPC H04W 16/14; G06Q 40/055; H04L 41/16; H04L 43/10; G06Q 2220/10

(57) ABSTRACT

The present disclosure relates to a device, a method and a medium in a spectrum sharing system. There is provided an electronic device comprising processing circuitry configured to: receive a spectrum request from a spectrum request system; send heartbeat interval information to the spectrum request system, the heartbeat interval information indicating a heartbeat interval at which the spectrum request system sends heartbeat requests, and the heartbeat interval information being shortest spectrum occupation time predicted based on spectrum usage data of the spectrum request system.

### CROSS-REFERENCE TO RELATED APPLICATIONS

The present application claims priority to China Patent Application No. 202310572430.X filed on May 19, 2023, and entitled “DEVICE, METHOD AND MEDIUM IN SPECTRUM SHARING SYSTEM”, which is incorporated herein by reference in its entirety.

### TECHNICAL FIELD

The present disclosure relates to wireless communication, specifically, to a device, a method and a medium for a spectrum sharing system.

### BACKGROUND

In an existing spectrum sharing system, a low-priority system may share idle spectrum resources of a high-priority system. However, in the process of using the spectrum, the low-priority system shall periodically send heartbeat requests to a spectrum management apparatus to determine whether wireless transmission is allowed, so that the high-priority system may be protected from interference at any time.

### SUMMARY

Some embodiments of the present disclosure provide a device, a method, a medium and a computer program product for determining an interval of heartbeat requests in a spectrum sharing system.

According to one aspect of the present disclosure, there is provided an electronic device comprising processing circuitry configured to: receive a spectrum request from a spectrum request system; send heartbeat interval information to the spectrum request system, the heartbeat interval information indicating a heartbeat interval at which the spectrum request system sends heartbeat requests, and the heartbeat interval information being shortest spectrum occupation time predicted based on spectrum usage data of the spectrum request system.

According to another aspect of the present disclosure, there is provided an electronic device at a spectrum request system comprising processing circuitry configured to: acquire heartbeat interval information, the heartbeat interval information indicating a heartbeat interval at which the spectrum request system sends heartbeat requests, and the heartbeat interval information being shortest spectrum occupation time predicted based on spectrum usage data of the spectrum request system; and send the heartbeat requests based on the heartbeat interval to a spectrum management apparatus.

According to another aspect of the present disclosure, there is provided an electronic device comprising processing circuitry configured to: acquire spectrum usage data of a spectrum request system; and send shortest spectrum occupation time predicted based on the spectrum usage data of the spectrum request system as a heartbeat interval of the spectrum request system.

According to another aspect of the present disclosure, there is provided an electronic device for user access control comprising processing circuitry configured to: receive signature information from a user's user equipment, the signature information being generated based on the user's user address and a user access non-fungible token (NFT) ID; verify the received signature information on a blockchain; send a user authentication result based on the verification of the signature information to the user equipment; and in response to user authentication is passed, allow the user equipment to access the Internet.

According to another aspect of the present disclosure, there is provided an electronic device for a user equipment comprising processing circuitry configured to: after connecting to an access point, send signature information to the access point, the signature information being generated based on a user's user address and a user access non-fungible token (NFT) ID; receive a user authentication result from the access point; in a case where user authentication is passed, access the Internet.

According to another aspect of the present disclosure, there is provided a method of determining a heartbeat interval of a spectrum request system, comprising: receive a spectrum request from the spectrum request system; and send heartbeat interval information to the spectrum request system, the heartbeat interval information indicating a heartbeat interval at which the spectrum request system sends heartbeat requests, and the heartbeat interval information being shortest spectrum occupation time predicted based on spectrum usage data of the spectrum request system.

According to another aspect of the present disclosure, there is provided a method of determining a heartbeat interval of a spectrum request system, comprising: acquire heartbeat interval information, the heartbeat interval information indicating a heartbeat interval at which the spectrum request system sends heartbeat requests, and the heartbeat interval information being shortest spectrum occupation time predicted based on spectrum usage data of the spectrum request system; and send the heartbeat requests based on the heartbeat interval to a spectrum management apparatus.

According to another aspect of the present disclosure, there is provided a method of determining a heartbeat interval of a spectrum request system, comprising: acquire spectrum usage data of the spectrum request system; send shortest spectrum occupation time predicted based on the spectrum usage data of the spectrum request system as the heartbeat interval of the spectrum request system.

According to another aspect of the present disclosure, there is provided a non-transitory computer-readable storage medium with program instructions stored thereon, which when executed by a processor cause the processor to perform the method of the present disclosure.

According to another aspect of the present disclosure, there is provided a computer program product including program instructions, which when executed by a processor cause the processor to perform the method of the present disclosure.

### DRAWINGS

When the following detailed description of embodiments is considered in conjunction with the drawings, it is possible to obtain better understanding of the present disclosure. The same or similar reference numerals are used in the respective drawings to denote the same or similar components. Together with the following detailed description, the respective drawings are incorporated in and form a part of this specification, serve to exemplify some embodiments of the present disclosure and explain principles and advantages of the present disclosure.

FIG. 1 is a schematic diagram illustrating a spectrum sharing system according to some embodiments of the present disclosure.

FIG. 2 is a schematic diagram illustrating state transitions of a spectrum request system that requests sharing spectra according to some embodiments of the present disclosure.

FIG. 3 is a schematic diagram illustrating a heartbeat process in a spectrum sharing system according to some embodiments of the present disclosure.

FIG. 4 is a schematic diagram illustrating a heartbeat interval determination process of a spectrum request system according to some embodiments of the present disclosure.

FIG. 5 is a schematic diagram illustrating a blockchain network according to some embodiments of the present disclosure.

FIG. 6 is a schematic diagram illustrating a structure of a full node in a blockchain network according to some embodiments of the present disclosure.

FIG. 7 is a schematic diagram illustrating a heartbeat interval determination process of a spectrum request system as a full node/accounting node in a blockchain network according to some embodiments of the present disclosure.

FIG. 8 is a schematic diagram illustrating a heartbeat interval determination process of a spectrum request system as a light node in a blockchain network according to some embodiments of the present disclosure, wherein the nearest full node/accounting node to the light node is a spectrum management apparatus for the spectrum request system.

FIG. 9 is a schematic diagram illustrating a heartbeat interval determination process of a spectrum request system as a light node in a blockchain network according to some embodiments of the present disclosure, wherein the nearest full node/accounting node to the light node is not a spectrum management apparatus for the spectrum request system.

FIG. 10 is a schematic diagram illustrating a spectrum allocation process on a blockchain according to some embodiments of the present disclosure.

FIG. 11 is a schematic diagram illustrating a process of acquiring heartbeat interval information according to some embodiments of the present disclosure.

FIG. 12 is a schematic diagram illustrating a prediction model training process based on federated learning according to some embodiments of the present disclosure.

FIG. 13 is a schematic diagram illustrating a structure of a computing platform 1300 according to some embodiments of the present disclosure.

FIG. 14 is a schematic diagram illustrating a scenario of using TVWS as a backbone network according to some embodiments of the present disclosure.

FIG. 15 is a schematic diagram illustrating an auction process of a user access non-fungible token (NFT) according to some embodiments of the present disclosure.

FIG. 16 illustrates a process of a WiFi user accessing the Internet according to some embodiments of the present disclosure.

FIG. 17 is a diagram illustrating an Internet access process in which user authentication is implemented by a spectrum management apparatus according to some embodiments of the present disclosure.

FIG. 18 is a diagram illustrating an Internet access process in which user authentication is implemented by a WiFi access point according to some embodiments of the present disclosure.

FIG. 19 is a block diagram illustrating an example of a schematic configuration of a computation device to which the technology of the present disclosure may be applied.

FIG. 20 is a block diagram illustrating a first example of a schematic configuration of a gNB to which the technology of the present disclosure may be applied.

FIG. 21 is a block diagram illustrating a second example of a schematic configuration of a gNB to which the technology of the present disclosure may be applied.

FIG. 22 is a block diagram illustrating an example of a schematic configuration of a smartphone to which the technology of the present disclosure may be applied.

FIG. 23 is a block diagram illustrating an example of a schematic configuration of a car navigation device to which the technology of the present disclosure may be applied.

### DETAILED DESCRIPTION

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

FIG. 1 is a schematic diagram illustrating a spectrum sharing system 100 according to some embodiments of the present disclosure. The spectrum sharing system 100 includes a plurality of nodes, such as one or more high-priority systems, one or more low-priority systems, and a regulator. Mobile Edge Computing (MEC) servers or computing platforms may be deployed around some nodes. The spectrum sharing system 100 may further include one or more spectrum management apparatuses as one or more nodes, which may be implemented by MEC servers surrounding the above-mentioned nodes or by separate servers. The spectrum management apparatus is used for managing spectrum allocation, it coordinates spectrum access of different users to ensure interference-free operation.

In some embodiments of the present disclosure, a plurality of nodes in the spectrum sharing system 100 may access a blockchain network via the Internet. Each node is identified by a unique address on the blockchain. When the spectrum sharing system 100 includes a 5G system, processing of functions of the blockchain may be completed by a core network of the 5G system. Although the spectrum sharing system 100 shown in FIG. 1 supports the blockchain network, some embodiments of the present disclosure may be practiced without the blockchain network.

In some embodiments of the present disclosure, the spectrum sharing system 100 may be a spectrum sharing system based on Citizens Broadband Radio Service (CBRS). CBRS is a wireless communication technology that utilizes the 3.5 GHz frequency band. CBRS adopts a sharing spectrum mode, in which there is a three-layer spectrum sharing architecture, including an Incumbent layer, a Priority Access License (PAL) layer and a General Authorization Access (GAA) layer. The Incumbent layer has priority over the PAL layer and the GAA layer, and the PAL layer has priority over the GAA layer. Incumbent layer users have primary access to the spectrum and are protected from interference. PAL layer users and GAA layer users may dynamically access the spectrum when it is idle. This framework ensures efficient spectrum utilization and reduces interference among users. The PAL layer is designed for users holding PALs, who obtain licenses in specific geographic areas and have a higher access priority than the GAA layer users. The GAA layer allows users to dynamically access the spectrum on a secondary basis without holding specific licenses. The GAA layer users need to comply with certain power and interference restrictions to ensure fair spectrum sharing.

According to some embodiments of the present disclosure, the high-priority systems in the spectrum sharing system 100 may be the PAL layer users, and the low-priority systems in the spectrum sharing system 100 may be the GAA layer users. In addition, the spectrum sharing system 100 may further include the Incumbent layer users.

In some embodiments of the present disclosure, the spectrum sharing system 100 may be a spectrum sharing system based on TV White Space (TVWS). In the spectrum sharing system 100, the high-priority systems may be television stations. In the spectrum sharing system 100, the low-priority systems may be base station devices (master devices) serving as TVWS access points, and substation devices (slave devices) serving as TVWS terminals may connect to the TVWS access points. In the spectrum sharing system 100, the spectrum management apparatus may be a geographic location database. The TVWS access point may send a spectrum request to the spectrum management apparatus to request available channel and power information.

The spectrum sharing system according to the embodiments of the present disclosure realizes dynamic spectrum sharing by leveraging technologies such as spectrum sensing and database-based access, etc. It can achieve efficient spectrum utilization and effectively increase the capacity of wireless networks.

The spectrum sharing system according to the embodiments of the present disclosure provides opportunities for various applications, including private LTE/5G networks, fixed wireless access, industrial Internet of Things, smart cities, rural connectivity, etc. It provides a cost-effective solution for deploying wireless networks, especially in areas with limited infrastructure.

Communication processes according to some embodiments of the present disclosure will be described below in conjunction with the accompanying drawings. It is noted that each of the high-priority systems and low-priority systems may include base stations and user terminals served by the base stations. When describing the communication processes of the high-priority systems and the low-priority systems, generally, the base stations of the high-priority systems and the low-priority systems perform the operations.

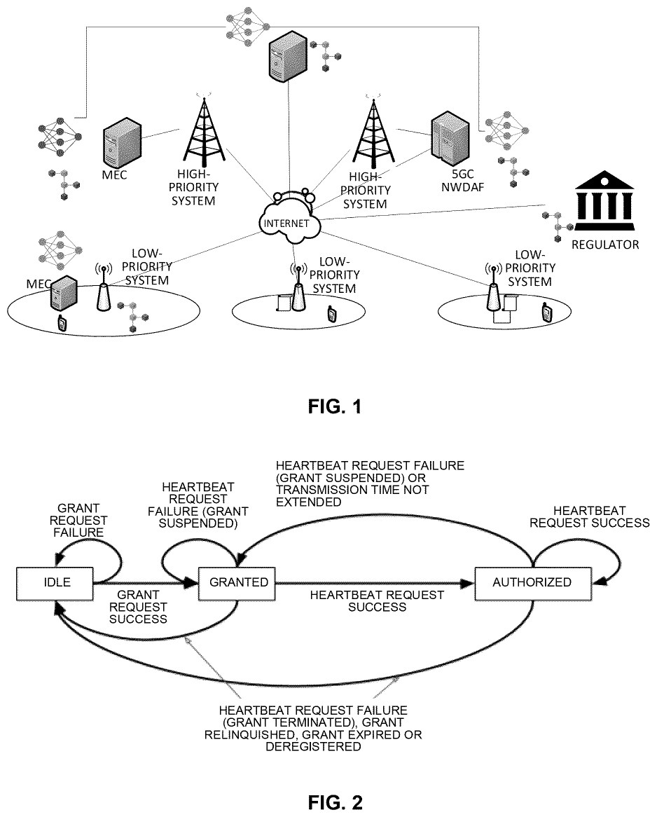

FIG. 2 is a schematic diagram illustrating state transitions of a spectrum request system that requests sharing spectra according to some embodiments of the present disclosure. When a granted spectrum request system intends to start using a spectrum for data transmission, it needs to first send a heartbeat request to a spectrum management apparatus. After the spectrum management apparatus performs spectrum protection calculation and returns a heartbeat request success indication, the transmission can then begin. In some embodiments of the present disclosure, the spectrum request system may be, for example, the low-priority system in the spectrum sharing system.

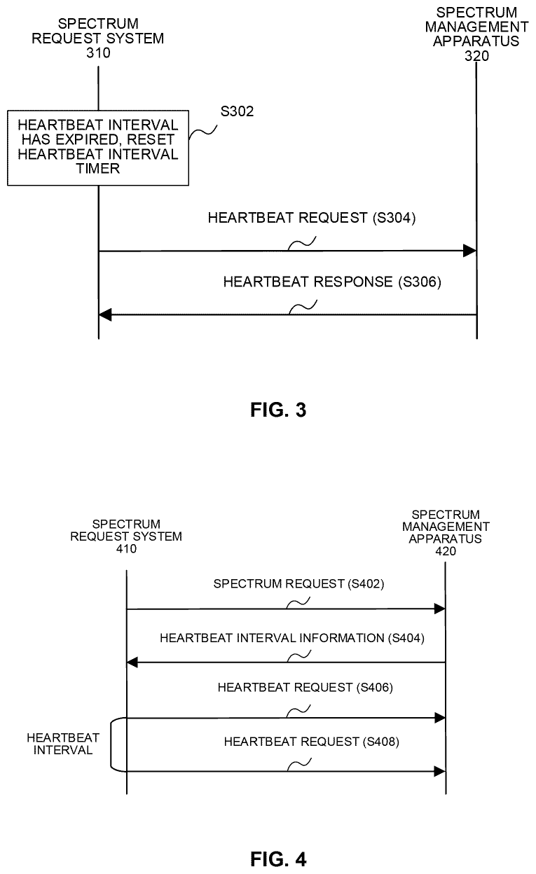

FIG. 3 is a schematic diagram illustrating a heartbeat process in a spectrum sharing system according to some embodiments of the present disclosure. In step S302, after determining that a heartbeat interval has expired, a spectrum request system 310 resets a heartbeat interval timer. In step S304, the spectrum request system 310 sends a heartbeat request to a spectrum management apparatus 320, the spectrum management apparatus 320 receives the heartbeat request. In step S306, in response to the heartbeat request, the spectrum management apparatus 320 sends a heartbeat response to the spectrum request system 310 to indicate heartbeat request success or heartbeat request failure, and the spectrum request system 310 receives the heartbeat response.

In the related art, the spectrum request system is required to send a heartbeat request to the spectrum management apparatus at most every 240 seconds to continue obtaining spectrum authorization. If there is no successful heartbeat process for seven consecutive days, it is considered that its connection with the spectrum management apparatus is lost. The spectrum management apparatus can determine whether the spectrum request system is using spectrum resources according to the heartbeat request from the spectrum request system. If the interval at which the spectrum request system sends the heartbeat requests is too long, it may be impossible to monitor its usage of the spectrum resources in real time, while if the interval is too short, it will impose substantial transmission overhead on the network. In addition, in a case where the spectrum sharing system constitutes a blockchain network, the heartbeat requests will be broadcast across the entire network. At this point, if heartbeat requests are too frequent, they will impose a large amount of transmission overhead on the blockchain network. Therefore, it is necessary to appropriately set the interval of the heartbeat requests to monitor its usage of the spectrum resources while avoiding excessive network transmission overhead.

Some embodiments of the present disclosure predict the shortest spectrum occupation time according to spectrum usage data and use this shortest spectrum occupation time as the interval for sending the heartbeat requests, so that it is possible to monitor the spectrum request system's usage of the spectrum resources while avoiding excessive network transmission overhead.

FIG. 4 is a schematic diagram illustrating a heartbeat interval determination process of a spectrum request system according to some embodiments of the present disclosure.

In step S402, a spectrum request system 410 sends a spectrum request to a spectrum management apparatus 420, the spectrum management apparatus 420 receives the spectrum request. In step S404, the spectrum management apparatus 420 sends heartbeat interval information to the spectrum request system 410, and the spectrum request system 410 receives the heartbeat interval information. The heartbeat interval information indicates a heartbeat interval at which the spectrum request system 410 sends heartbeat requests. In some embodiments of the present disclosure, the heartbeat interval information may be the shortest spectrum occupation time predicted based on spectrum usage data of the spectrum request system 410. The prediction of the shortest spectrum occupation time may be achieved through artificial intelligence. For example, the spectrum usage data may be input into a prediction model to obtain the shortest spectrum occupation time. The prediction may be implemented by the spectrum management apparatus, or by other nodes of the spectrum sharing system, or an external computing platform.

After receiving the heartbeat interval information, the spectrum request system 410 may send heartbeat requests to the spectrum management apparatus 420 based on the heartbeat interval indicated in the heartbeat interval information. In step S406, the spectrum request system 410 sends a heartbeat request to the spectrum management apparatus 420, the spectrum management apparatus 420 receives the heartbeat request. After the heartbeat interval, in step S408, the spectrum request system 410 sends a heartbeat request to the spectrum management apparatus 420 again, and the spectrum management apparatus 420 receives the heartbeat request.

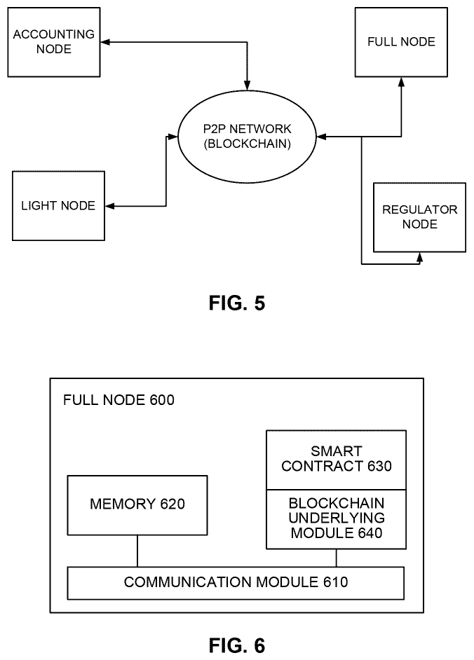

In some embodiments of the present disclosure, respective nodes in the spectrum sharing system may form a blockchain network. FIG. 5 is a schematic diagram illustrating a blockchain network according to some embodiments of the present disclosure. The blockchain network includes light nodes, full nodes, accounting nodes, and regulator nodes. The full node has complete blockchain functions, stores all blocks from the first block to the latest block, can receive and broadcast all transactions and verify transactions and blocks, and may achieve complete anonymity. The light node is connected to the full node, only needs to download the latest block hash to verify transactions, and stores transactions related to itself. The accounting node has all the functions of the full node and is responsible for generating and adding new blocks. The high-priority systems and low-priority systems in the spectrum sharing system may choose to act as light nodes, full nodes, or accounting nodes in the blockchain network according to their own communication, computation and storage resources. The spectrum management apparatus in the spectrum sharing system generally acts as a full node or an accounting node.

FIG. 6 is a schematic diagram illustrating a structure of a full node 600 in a blockchain network according to some embodiments of the present disclosure. The full node 600 includes a memory 620 for storing spectrum metadata, including spectrum usage data and spectrum trading data. The spectrum usage data may include, for example, starting frequency, bandwidth, ending frequency, transmission power, occupation time, usage location, azimuth angle, elevation angle, etc. Additionally, the full node 600 has a blockchain underlying module 640, such as a public chain, a consortium chain, etc. The full node 600 is also deployed with a smart contract 630 for spectrum trading and NFT creation. The smart contract 630 may utilize an NFT protocol (e.g., ERC 721 protocol) to create NFTs for spectrum resources. The full node 600 may interact with other nodes in the network through a communication module 610 (e.g., a TCP/IP interface).

The spectrum request system may be a full node, an accounting node, or a light node in the blockchain network. In a case where the spectrum request system is a full node/accounting node, it may directly broadcast a spectrum request in the blockchain network to initiate a spectrum allocation process on the blockchain. In a case where the spectrum request system is a light node, it needs to send a spectrum request to the nearest full node/accounting node, which then broadcasts the spectrum request in the blockchain network to initiate a spectrum allocation process on the blockchain.

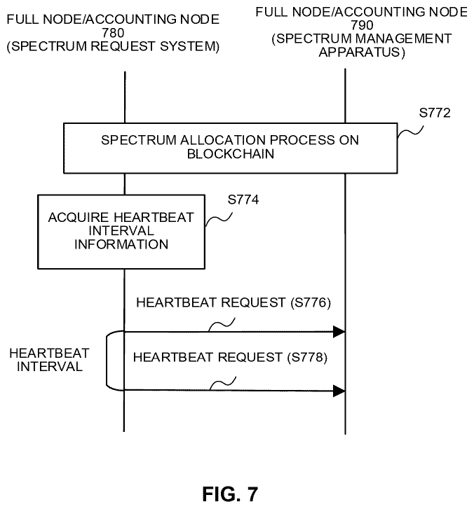

FIG. 7 is a schematic diagram illustrating a heartbeat interval determination process of a spectrum request system as a full node/accounting node in a blockchain network according to some embodiments of the present disclosure. A full node/accounting node 780, acting as the spectrum request system, directly broadcasts a spectrum request in the blockchain network to initiate a spectrum allocation process on the blockchain. In step S772, the full nodes and accounting nodes in the blockchain network execute the spectrum allocation process for the spectrum request system. In step S774, the full node/accounting node 780, as the spectrum request system, acquires heartbeat interval information, which indicates a heartbeat interval at which the spectrum request system sends heartbeat requests. In some embodiments of the present disclosure, the heartbeat interval information may be the shortest spectrum occupation time predicted based on spectrum usage data of the spectrum request system. The prediction of the shortest spectrum occupation time may be achieved through artificial intelligence. For example, the spectrum usage data may be input into a prediction model to obtain the shortest spectrum occupation time. The prediction of the shortest spectrum occupation time may be implemented by the full node/accounting node 780 itself as the spectrum request system, or by other nodes in the spectrum sharing system, or by an external computing platform.

After acquiring the heartbeat interval information, the full node/accounting node 780, acting as the spectrum request system, may send heartbeat requests to a full node/accounting node 790, acting as a spectrum management apparatus, based on the heartbeat interval indicated in the heartbeat interval information. In step S776, the full node/accounting node 780, as the spectrum request system, sends a heartbeat request to the full node/accounting node 790, as the spectrum management apparatus, and the full node/accounting node 790, as the spectrum management apparatus, receives the heartbeat request. After the heartbeat interval, in step S778, the full node/accounting node 780, as the spectrum request system, again sends a heartbeat request to the full node/accounting node 790, as the spectrum management apparatus, and the full node/accounting node 790, as the spectrum management apparatus, receives the heartbeat request.

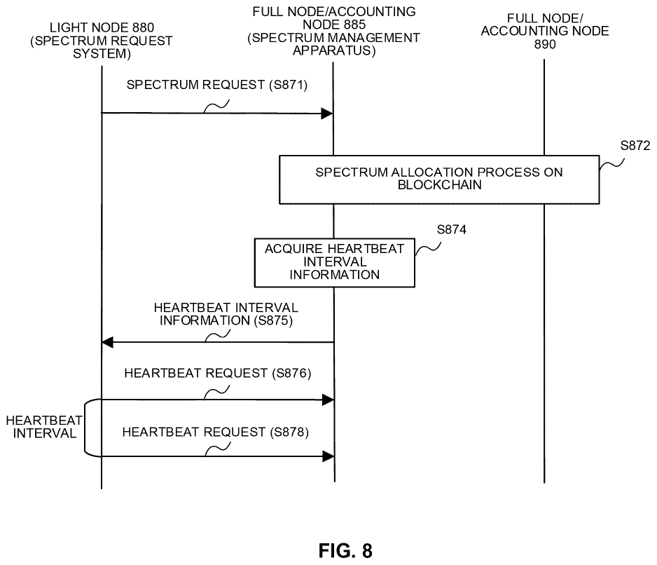

FIG. 8 is a schematic diagram illustrating a heartbeat interval determination process of a spectrum request system as a light node in a blockchain network according to some embodiments of the present disclosure, wherein the nearest full node/accounting node to the light node is a spectrum management apparatus for the spectrum request system. In step S871, a light node 880, acting as the spectrum request system, sends a spectrum request to the nearest full node/accounting node 885, the full node/accounting node 885 receives the spectrum request. In this embodiment, the full node/accounting node 885 happens to be the spectrum management apparatus for the spectrum request system. In step S872, the full node/accounting node 885, acting as the spectrum management apparatus, broadcasts the spectrum request in the blockchain network, and the blockchain network executes a spectrum allocation process for the spectrum request system. The spectrum allocation process on the blockchain is performed by the full nodes and the accounting nodes in the blockchain network. In step S874, the full node/accounting node 885, as the spectrum management apparatus, acquires heartbeat interval information, which indicates a heartbeat interval at which the spectrum request system sends heartbeat requests. In some embodiments of the present disclosure, the heartbeat interval information may be the shortest spectrum occupation time predicted based on spectrum usage data of the spectrum request system. The prediction of the shortest spectrum occupation time may be implemented by the full node/accounting node 885 itself as the spectrum management apparatus, or by other nodes in the spectrum sharing system, or by an external computing platform.

In step S875, the full node/accounting node 885, acting as the spectrum management apparatus, sends the heartbeat interval information to the light node 880, acting as the spectrum request system, and the light node 880, acting as the spectrum request system, receives the heartbeat interval information. After receiving the heartbeat interval information, the light node 880, as the spectrum request system, may send heartbeat requests to the full node/accounting node 885, as the spectrum management apparatus, based on the heartbeat interval indicated in the heartbeat interval information. In step S876, the light node 880, as the spectrum request system, sends a heartbeat request to the full node/accounting node 885, as the spectrum management apparatus, and the full node/accounting node 885, as the spectrum management apparatus, receives the heartbeat request. After the heartbeat interval, in step S878, the light node 880, as the spectrum request system, again sends a heartbeat request to the full node/accounting node 885, as the spectrum management apparatus, and the full node/accounting node 885, as the spectrum management apparatus, receives the heartbeat request.

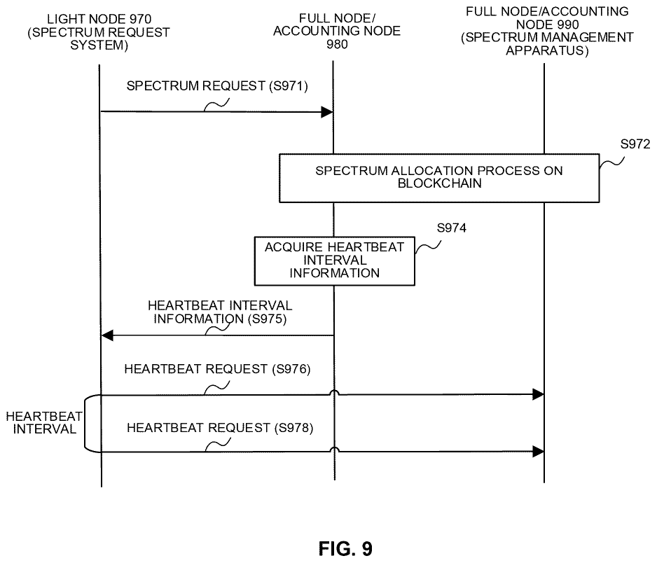

FIG. 9 is a schematic diagram illustrating a heartbeat interval determination process of a spectrum request system as a light node in a blockchain network according to some embodiments of the present disclosure, wherein the nearest full node/accounting node to the light node is not a spectrum management apparatus for the spectrum request system. In step S971, a light node 970, acting as the spectrum request system, sends a spectrum request to the nearest full node/accounting node 980, and the full node/accounting node 980 receives the spectrum request. In this embodiment, the full node/accounting node 980 is not the spectrum management apparatus for the spectrum request system. For example, the full node/accounting node 980 may be a certain high-priority system. In step S972, the full node/accounting node 980 broadcasts the spectrum request in the blockchain network, and the blockchain network executes a spectrum allocation process for the spectrum request system. The spectrum allocation process on the blockchain is performed by the full nodes and the accounting nodes in the blockchain network. In step S974, the full node/accounting node 980 acquires heartbeat interval information, which indicates a heartbeat interval at which the spectrum request system sends heartbeat requests. In some embodiments of the present disclosure, the heartbeat interval information may be the shortest spectrum occupation time predicted based on spectrum usage data of the spectrum request system. The prediction of the shortest spectrum occupation time may be implemented by the full node/accounting node 980 itself, or by other nodes in the spectrum sharing system, or by an external computing platform.

In step S975, the full node/accounting node 980 sends the heartbeat interval information to the light node 970 acting as the spectrum request system, and the light node 970 acting as the spectrum request system receives the heartbeat interval information. After receiving the heartbeat interval information, the light node 970 as the spectrum request system may send heartbeat requests to a full node/accounting node 990 as the spectrum management apparatus based on the heartbeat interval indicated in the heartbeat interval information. In step S976, the light node 970 as the spectrum request system sends a heartbeat request to the full node/accounting node 990 as the spectrum management apparatus, and the full node/accounting node 990 as the spectrum management apparatus receives the heartbeat request. After the heartbeat interval, in step S978, the light node 970 as the spectrum request system again sends a heartbeat request to the full node/accounting node 990 as the spectrum management apparatus, and the full node/accounting node 990 as the spectrum management apparatus receives the heartbeat request.

It should be noted that although the blockchain networks in FIGS. 7 to 9 only show several nodes, they may include more nodes.

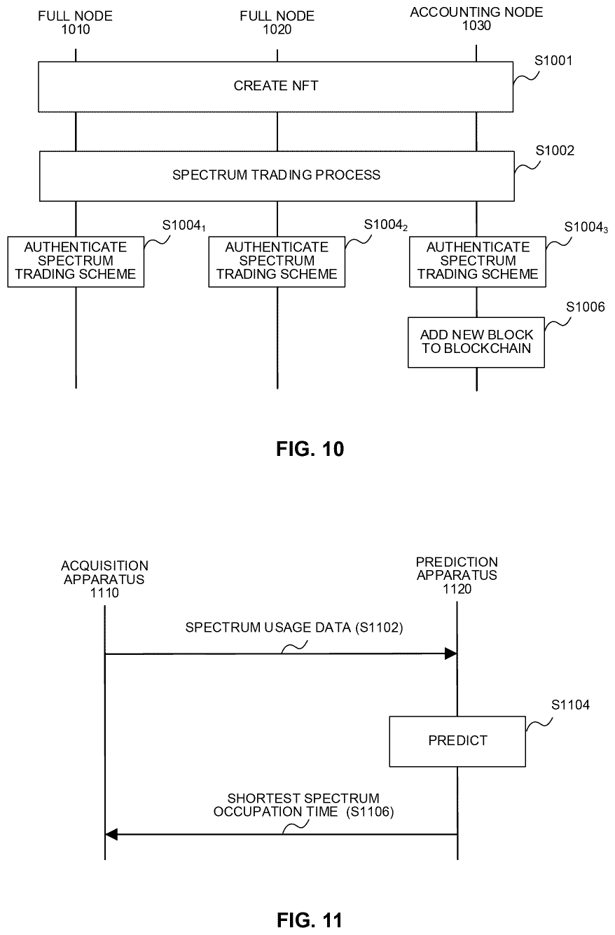

FIG. 10 is a schematic diagram illustrating a spectrum allocation process on a blockchain according to some embodiments of the present disclosure. In step S1001, a full node 1010, a full node 1020, and an accounting node 1030 in a blockchain network create non-fungible tokens (NFTs) for available spectrum resources according to a smart contract protocol. Spectrum metadata of available spectrum resources is stored locally in the full nodes, and each full node/accounting node has a corresponding relationship between the spectrum metadata and the NFTs. In step S1002, the full nodes 1010, 1020 and the accounting node 1030 in the blockchain network perform a spectrum trading process on a spectrum request of a spectrum request system based on the NFTs to generate NFT-based spectrum trading schemes. In the spectrum trading process, nodes on the blockchain provide available spectrum resources to the spectrum request system based on the NFTs by methods such as bidding, and generate one or more NFT-based trading schemes. Each spectrum trading scheme may include addresses of both trading parties, NFT IDs, etc. In steps S10041, S10042, and S10043, the full nodes 1010, 1020 and the accounting node 1030 authenticate the one or more spectrum trading schemes. The authentication of the spectrum trading schemes may include interference authentication, identity authentication, spectrum validity authentication, etc. In step S1006, the accounting node 1030 packages spectrum trading schemes, which pass the authentication, into a new block and adds it to the blockchain. Although FIG. 10 only shows the full node 1010, the full node 1020, and the accounting node 1030, the blockchain network may include more full nodes/accounting nodes participating in the spectrum allocation process.

Each full node/accounting node stores all spectrum metadata, however, as time passes and data accumulates, the blockchain will consume a significant amount of storage and communication resources, reducing processing efficiency. In some embodiments of the present disclosure, NFTs are utilized in the blockchain network to replace spectrum metadata. NFTs are characterized by “Unique and Public”, “Non-tamperable:”, “Easy Right Confirmation”, “Tradable”, etc. By using NFTs, unique representation of spectrum resources may be achieved (unique ID and metadata), and encryption of spectrum sales and leases is enabled. Therefore, it is possible to reduce communication overhead and protect data privacy.

In some embodiments of the present disclosure, the shortest spectrum occupation time of the spectrum request system may be predicted based on the spectrum usage data of the spectrum request system. The prediction of the shortest spectrum occupation time may be implemented by the spectrum management apparatus or by other prediction apparatuses, the prediction apparatuses may be located in other nodes in the spectrum sharing system or in external computing platforms.

FIG. 11 is a schematic diagram illustrating a process of acquiring heartbeat interval information according to some embodiments of the present disclosure. In step S1102, an acquisition apparatus 1110 sends spectrum usage data of a spectrum request system to a prediction apparatus 1120, and the prediction apparatus 1120 acquires the spectrum usage data. In step S1104, the prediction apparatus predicts the shortest spectrum occupation time based on the spectrum usage data of the spectrum request system. In step S1106, the prediction apparatus 1120 sends the predicted shortest spectrum occupation time to the acquisition apparatus 1110 as the heartbeat interval information of the spectrum request system, and the acquisition apparatus 1110 receives the heartbeat interval information.

The acquisition apparatus 1110 may be the spectrum management apparatus 420 in FIG. 4, the full node/accounting node 780 as the spectrum request system in FIG. 7, the full node/accounting node 885 as the spectrum management apparatus in FIG. 8, or the full node/accounting node 980 in FIG. 9. The prediction apparatus 1120 for the shortest spectrum occupation time may be implemented by a node in the spectrum sharing system or an external computing platform.

In some embodiments of the present disclosure, the prediction of the shortest spectrum occupation time may utilize a prediction model. The training of the prediction model may be implemented on a computing platform, NWDAF, or the spectrum management apparatus. The training of the prediction model may use various machine learning algorithms, including supervised learning, unsupervised learning, and reinforcement learning. Reinforcement learning is to learn decisions, classifications, and behaviors, by a method of optimizing reward functions for taking certain actions in a certain state, that is, learn to take appropriate actions in a certain environment to maximize future rewards. When using reinforcement learning, the reward function may be set to the transmission overhead of the blockchain network.

In some embodiments of the present disclosure, a training process of the prediction model may be based on Federated Learning (FL). Federated learning may improve a model training speed while protecting data privacy.

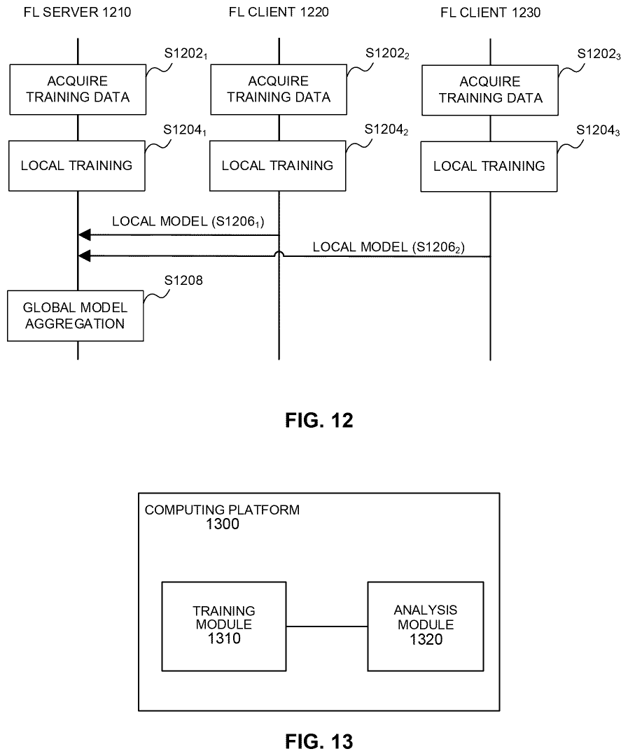

FIG. 12 is a schematic diagram illustrating a prediction model training process based on federated learning according to some embodiments of the present disclosure. In steps S12021, S12022 and S12023, an FL server 1210, an FL client 1220 and an FL client 1230 respectively acquire training data, such as spectrum usage data. In steps S12041, S12042 and S12043, the FL server 1210, the FL client 1220 and the FL client 1230 respectively perform local training based on the training data to obtain local models. In steps S12061 and S12062, the FL client 1220 and the FL client 1230 send the trained local models to the FL server 1210 respectively, and the FL server 1210 receives these local models. In step S1208, the FL server 1210 globally aggregates respective local models to obtain a global model. The FL server 1210 may distribute the aggregated global model to the FL client 1220 and FL client 1230. The FL client 1220 and the FL client 1230 receive the aggregated global model and use the global model for the next round of local training. Steps S1204 to S1208 may be repeatedly executed for multiple rounds to obtain a final global model as the prediction model. It should be noted that the prediction model training process shown in FIG. 12 may include more FL clients. Additionally, in some embodiments of the present disclosure, the FL server 1210 itself may not perform steps S12021 and S12041.

The FL server 1210, the FL client 1220, and the FL client 1230 may be located at nodes with computing capability in the spectrum sharing system or at external computing platforms. The FL server 1210 may provide the trained prediction model to the prediction apparatus, which may be located at one or more nodes in the spectrum sharing system or an external computing platform.

FIG. 13 is a schematic diagram illustrating a structure of a computing platform 1300 according to some embodiments of the present disclosure. The computing platform 1300 includes a training module 1310 and an analysis module 1320. The training module 1310 may be configured to train a prediction model for predicting the shortest spectrum occupation time of a spectrum request system. The analysis module 1320 may be configured to predict the shortest spectrum occupation time of the spectrum request system based on spectrum usage data of the spectrum request system. The computing platform 1300 may be an edge computing platform deployed by an operator for base stations, the operator's own computing center, or other public cloud computing facilities. The computing platform 1300 may also be an intelligent module for cellular 5G networks, such as 5GC Network Data Analytics Function (NWDAF), or an NG-RAN node, etc. The computing platform 1300 may be implemented by a single server or by a plurality of servers located at different positions.

In some embodiments of the present disclosure, the spectrum sharing system may utilize Television White Spaces (TVWS) for spectrum sharing. The television white spaces technology is an emerging technology that utilizes idle television spectrum resources. It is based on the principle of cognitive radio, and uses the unoccupied television spectra for the transmission of the low-priority systems by monitoring and identifying the spectrum usage in real time, thereby improving spectrum utilization efficiency. Traditional television broadcasting uses fixed frequency bands for signal transmission, but, due to the limited spectrum resources, it is prone to spectrum congestion and signal interference. However, the television white spaces technology may achieve dynamic spectrum access and sharing, make adaptive adjustments based on the real-time spectrum environment to avoid spectrum conflicts and improve spectrum utilization efficiency. The television white spaces technology also has high anti-interference capability, which may effectively reduce signal interference and multipath effects in the transmission. This technology not only provides better television services, but also offers a solution in scenarios where spectrum resources are tight. It provides new possibilities for the efficient utilization and sharing of radio spectra.

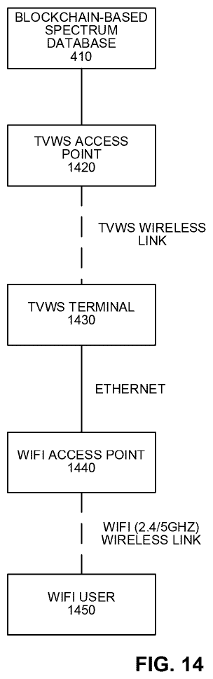

FIG. 14 is a schematic diagram illustrating a scenario of using TVWS as a backbone network according to some embodiments of the present disclosure. The figure shows a blockchain-based spectrum database (spectrum management apparatus) 1410, a TVWS access point 1420, a TVWS terminal 1430, a WiFi access point 1440, and a WiFi user 1450. The TVWS terminal 1430 provides a network to the WiFi user 1450 via the WiFi access point 1440. The TVWS access point 1420 may be a low-priority system in a spectrum sharing system, and the TVWS terminal may be a customer premise equipment (CPE) connected to the TVWS access point and using a shared frequency band.

In the prior art, TVWS network operators are unable to control the access of end users and implement billing. In some embodiments of the present disclosure, after a low-priority system is allocated available spectrum resources, user access control is performed based on NFT distribution and auction, and spectrum usage rights are transferred among users, thereby achieving control over and billing for access of end users.

In some embodiments of the present disclosure, the blockchain-based spectrum database generates user access NFTs for spectrum resources allocated to each TVWS access point. The user access NFTs may be generated based on an ERC4907 protocol. Compared with ERC721, the ERC4907 protocol can lease an NFT's usage duration to make a user who has obtained a usage right of the NFT use corresponding spectrum resources to access the network during the lease period, without changing the NFT's owner. The owner of the spectrum resources is the TVWS access point, the TVWS access point retains the ownership of the spectrum resources and splits the usage rights to grant them to the WiFi users.

Each WiFi user may have its own blockchain wallet, corresponding to a unique user address. Input parameters of a generation function of the user access NFT may include one or more of spectrum bandwidth, geographical location of spectrum resources, access point capacity, QoS requirements, and backbone network resources, output parameters may include one or more of the number of NFTs and NFTs with unique IDs.

Function 1 is an example of a generation function of a user access NFT.

Function 1: a generation function of a user access NFT

```
Input: _name,_channel,_location,_time, and optional parameters
Output: user access NFT
  function createSpectrum onlyOwner
      Spectrum memory spectrum = Spectrum(
        // NFT ID
        id: _id
        // NFT name
        name: _name
      // NFT owner address
        addressOwner: msg.sender
      // bandwith
        channel:_channel
      // location
        location:_location)
    mint(spectrum)
    emit LogMint
    end function
```

An example of detailed information of the user access NFT is as follows:
Owner Address: 0xcCE7f95119214FC1c7Ad7188C945732C3f276ACe
Contract Address: 0x82347fBcDDAbb5a19F5193d52315563A76A9f973
Creator Address: 0xcCE7f95119214FC1c7Ad7188C945732C3f276ACe
NFT ID: 1
Token Standard: ERC4907.

After a user requests or purchases a user access NFT from a network provider, an owner address of the user access NFT is changed to the user's address.

The user access NFT based on the ERC4907 protocol has the characteristic of being leasable. According to the user address of the successful bidder, the NFT ID, and the lease time, etc, as parameters, the leasehold right of the user access NFT thereof may be set. Function 2 is an example of a setting function of a lease duration of an NFT.

Function 2: setting of a lease duration

```
Input: NFT ID, lessee address, lease duration
Output: NFT leasehold right
  function setUser(
    uint256 tokenId
    address user
    uint64 expires) public virtual returns(bool)
      UserInfo storage info = _users[tokenId]
      info.user = user
      info.expires = expires
    emit UpdateUser(tokenId,user,expires)
      return true
    end function
```

In Function 2, tokenId is used to store the NFT ID, user is used to store the address of the user who has the NFT usage right, and expires stores expiration time of the usage right. An event UpdateUser receives a total of three parameters: the NFT ID (tokenId), the address of the user who has been granted the usage right (user), and the expiration time of the usage right (expires), this event will be triggered when the NFT user usage right is changed.

According to the user access NFT ID, users participate in the auction for the NFT lease duration corresponding to the user access NFT ID set by the spectrum management apparatus, thereby completing the on-chain auction for the NFT. The bidders are user terminals that desire to obtain the access right of the TVWS CPE. The bidders participate in the auction through an auction smart contract, and the successful bidder obtains the access right within the lease duration.

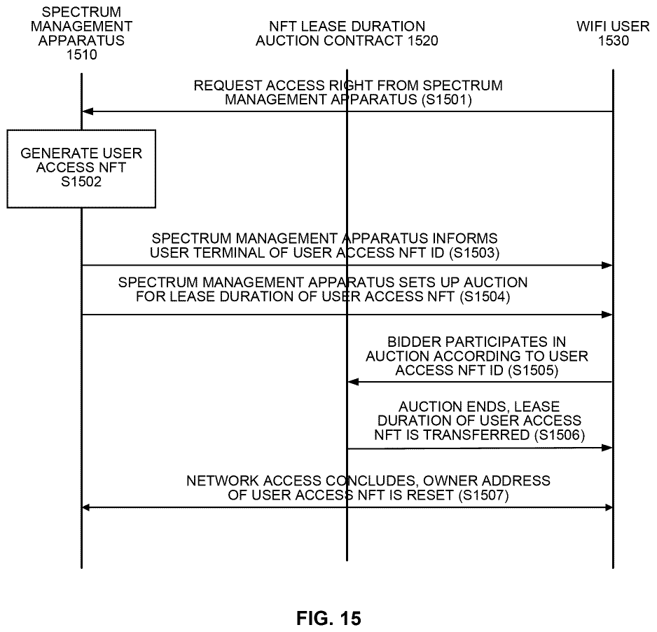

FIG. 15 is a schematic diagram illustrating an auction process of a user access non-fungible token (NFT) according to some embodiments of the present disclosure. In step S1501, a WiFi user 1530 sends an access request to a spectrum management apparatus 1510, and the spectrum management apparatus 1510 receives the access request. In step S1502, the spectrum management apparatus 1510 generates a user access NFT. In step S1503, the spectrum management apparatus 1510 sends a user access NFT ID to the WiFi user 1530, and the WiFi user 1530 receives the NFT ID.

In step S1504, the spectrum management apparatus 1510 sets up an auction for a lease duration of the user access NFT. Function 3 is an example of a setting function for auction eligibility, and this function can only be called by the spectrum manager.

Function 3: setting auction eligibility

```
function setPermission(
uint256 tokenId
bool permission) public ownerOnly {
    modifier ownerOnly
    require(msg.sender==_owner)
    bool[ ] tokenIdPermission
    tokenIdPermission[tokenId] = permission
  }
  end function
```

In step S1505, the WiFi user 1530 participates in the auction based on the NFT ID. An English auction format may be adopted, where the sum of the auction bids must be larger than the current highest bid (highestBid) so that the bid is to be considered valid. Function 4 is an example of an NFT auction function.

Function 4: NFT auction function

```
  function bid(uint256 tokenId) public payable {
      require(tokenIdPermission[tokenId] == true)
      require(block.timestamp <= auctionEnd1[tokenId])
      require(bidders[msg.sender][tokenId] +
      msg.value > highestBid[tokenId])
      if (auctionEnd1[tokenId] == 0)
        auctionEnd1[tokenId] = block.timestamp +bidding
        bidders[msg.sender][tokenId] += msg.value
        highestBidder[tokenId] = msg.sender
        highestBid[tokenId] = bidders[msg.sender][tokenId]
    emit HighestBid(msg.sender,highestBid[tokenId])
end function
```

In step S1506, the auction ends, and the lease duration of the user access NFT is transferred to the successful bidding WiFi user 1530, for example, the owner address of the user access NFT is set to the user address of the WiFi user 1530. In step S1507, after the WiFi user 1530's network access concludes (for example, upon the expiration of the NFT's lease duration), the spectrum management apparatus 1510 resets the owner address of the user access NFT.

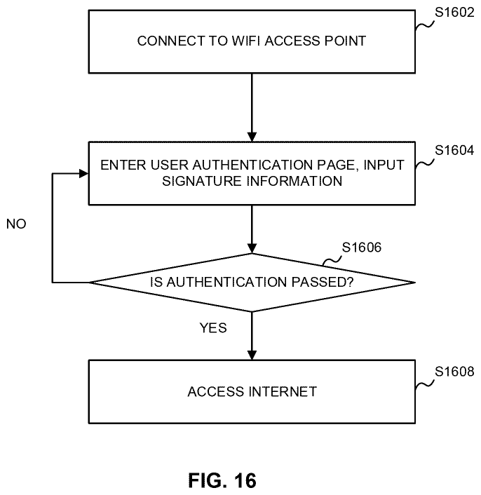

FIG. 16 illustrates a process of a WiFi user accessing the Internet according to some embodiments of the present disclosure. In step S1602, a user equipment of the WiFi user connects to a WiFi access point e.g. via an SSID and a network password (if any) of a WiFi network. At this time, the user equipment of the WiFi user only establishes a wireless connection with the WiFi access point and cannot use network services to access the Internet. In step S1604, the user equipment of the WiFi user jumps to a user authentication page and inputs signature information for user authentication. In some embodiments of the present disclosure, the signature information is generated based on a user address of the WiFi user and a user access NFT ID. In step S1606, based on the input signature information, the signature information is verified on a blockchain to determine whether the authentication passes. In step S1608, in a case where the authentication passes, the user equipment of the WiFi user may access the Internet. If the authentication fails, the next verification operation is performed. The user authentication based on the signature information may be implemented by a spectrum management apparatus or by the WiFi access point.

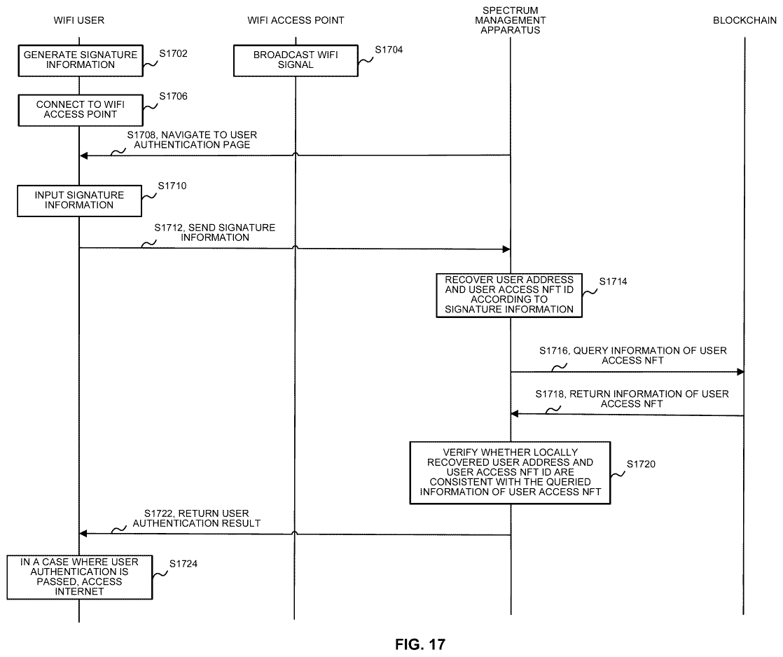

FIG. 17 is a diagram illustrating an Internet access process in which user authentication is implemented by a spectrum management apparatus according to some embodiments of the present disclosure. In step S1702, a user equipment of a WiFi user generates signature information based on a user address and a user access NFT ID. For example, the signature information is generated by encrypting the user address and the user access NFT ID with the user's private key. A process of the user creating an account on a blockchain platform typically involves generating a public-private key pair. The user needs to securely store the private key, and only the user who possesses the corresponding private key can generate valid signature information.

In step S1704, a WiFi access point periodically broadcasts a WiFi signal, which includes an SSID of a WiFi network. In step S1706, the user equipment of the WiFi user detects the WiFi signal including the SSID broadcast by the WiFi access point and connects to the WiFi access point. In some cases, the WiFi user needs to enter a network password of the WiFi network to connect to the WiFi access point. At this point, the user equipment of the WiFi user only establishes a wireless connection with the WiFi access point and cannot use network services to access the Internet.

In step S1708, the spectrum management apparatus instructs the user equipment of the WiFi user to navigate to a user authentication page. For example, the user equipment of the WiFi user sends an HTTP request to the spectrum management apparatus, and in response to the HTTP request, the spectrum management apparatus sends a user authentication trigger message to the user equipment, and in response to the user authentication trigger message, the user equipment then navigates to the user authentication page. In step S1710, the WiFi user inputs the signature information on the user authentication page. In step S1712, the user equipment of the WiFi user sends the signature information to the spectrum management apparatus. The signature information may be transmitted directly or transmitted securely via an encrypted channel.

After receiving the signature information, the spectrum management apparatus verifies the received signature information on the blockchain. In step S1714, the spectrum management apparatus recovers the user address and the user access NFT ID according to the received signature information. For example, the user address and the user access NFT ID are recovered by decrypting the received signature information with the public key. In step S1716, the spectrum management apparatus queries detailed information of the corresponding user access NFT on the blockchain. In step S1718, the blockchain returns the queried detailed information of the user access NFT to the spectrum management apparatus. In step S1720, the spectrum management apparatus verifies whether the locally recovered user address and user access NFT ID are consistent with the queried detailed information of the user access NFT. Additionally, if the corresponding user access NFT is not queried in step S1716, a query failure message is returned in step S1718 (e.g., the detailed information of the user access NFT is a NULL value). In this case, in step S1720, the spectrum management apparatus directly determines that the signature information verification fails.

In some embodiments of the present disclosure, the spectrum management apparatus sends the recovered user access NFT ID to the blockchain, and the blockchain returns the queried owner address of the user access NFT corresponding to the user access NFT ID to the spectrum management apparatus. The spectrum management apparatus compares the locally recovered user address with the queried owner address of the user access NFT. If the locally recovered user address is consistent with the queried owner address of the user access NFT, the signature information verification succeeds. If the locally recovered user address is not consistent with the queried owner address of the user access NFT, the signature information verification fails. In some embodiments of the present disclosure, the spectrum management apparatus sends the recovered user address to the blockchain, and the blockchain returns the queried user access NFT ID corresponding to the user address to the spectrum management apparatus. The spectrum management apparatus compares the locally recovered user access NFT ID with the queried user access NFT ID. If the locally recovered user access NFT ID is consistent with the queried user access NFT ID, the signature information verification succeeds. If the locally recovered user access NFT ID is not consistent with the queried user access NFT ID, the signature information verification fails.

In step S1722, the spectrum management apparatus returns a user authentication result based on the verification of the signature information to the user equipment of the WiFi user. If the signature information verification succeeds, the user authentication is passed. If the signature information verification fails, the user authentication is not passed. In step S1724, in a case where the user authentication is passed, the spectrum management apparatus allows the user equipment of the WiFi user to access the Internet.

It should be noted that the communication between the WiFi user and the spectrum management apparatus described above actually goes through the WiFi access point, the TVWS terminal, and the TVWS access point.

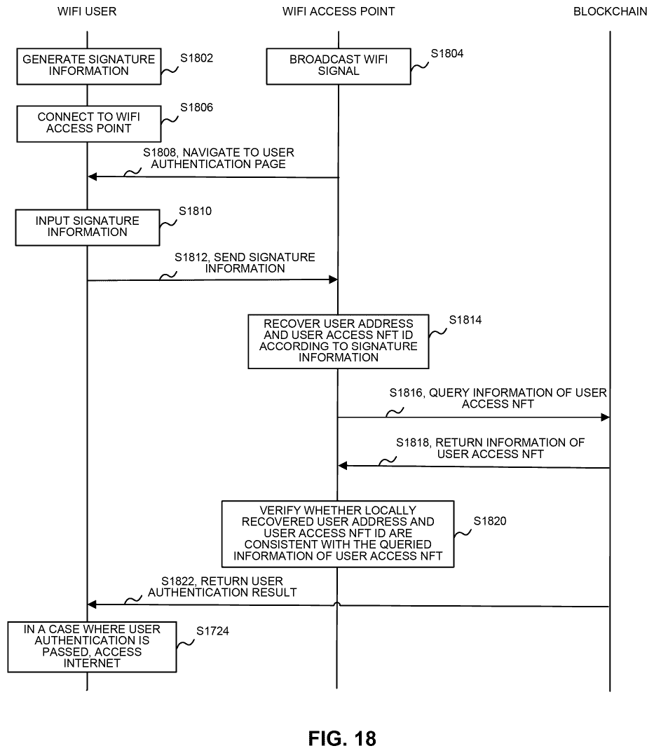

FIG. 18 is a diagram illustrating an Internet access process in which user authentication is implemented by a WiFi access point according to some embodiments of the present disclosure. In step S1802, a user equipment of a WiFi user generates signature information based on a user address and a user access NFT ID. For example, the signature information is generated by encrypting the user address and the user access NFT ID with the user's private key. A process of the user creating an account on a blockchain platform typically involves generating a public-private key pair. The user needs to securely store the private key, and only the user who possesses the corresponding private key can generate valid signature information.

In step S1804, the WiFi access point periodically broadcasts a WiFi signal, which includes an SSID of a WiFi network. In step S1806, the user equipment of the WiFi user detects the WiFi signal including the SSID broadcast by the WiFi access point and connects to the WiFi access point. In some cases, the WiFi user needs to enter a network password of the WiFi network to connect to the WiFi access point. At this point, the user equipment of the WiFi user only establishes a wireless connection with the WiFi access point and cannot use network services to access the Internet.

In step S1808, the WiFi access point instructs the user equipment of the WiFi user to navigate to a user authentication page. For example, the user equipment of the WiFi user sends an HTTP request to the WiFi access point, and in response to the HTTP request, the WiFi access point sends a user authentication trigger message to the user equipment, and in response to the user authentication trigger message, the user equipment then navigates to the user authentication page. In step S1810, the WiFi user inputs the signature information on the user authentication page. In step S1812, the user equipment of the WiFi user sends the signature information to the WiFi access point. The signature information may be transmitted directly or transmitted securely via an encrypted channel.

After receiving the signature information, the WiFi access point verifies the received signature information on the blockchain. In step S1814, the WiFi access point recovers the user address and the user access NFT ID according to the received signature information. For example, the user address and the user access NFT ID are recovered by decrypting the received signature information with the public key. In step S1816, the WiFi access point queries detailed information of the corresponding user access NFT on the blockchain. In step S1818, the blockchain returns the queried detailed information of the user access NFT to the WiFi access point. In step S1820, the WiFi access point verifies whether the locally recovered user address and user access NFT ID are consistent with the queried detailed information of the user access NFT. Additionally, if the corresponding user access NFT is not queried in step S1816, a query failure message is returned in step S1818 (e.g., the detailed information of the user access NFT is a NULL value). In this case, in step S1820, the WiFi access point directly determines that the signature information verification fails.

In some embodiments of the present disclosure, the WiFi access point sends the recovered user access NFT ID to the blockchain, and the blockchain returns the queried owner address of the user access NFT corresponding to the user access NFT ID to the WiFi access point. The WiFi access point compares the locally recovered user address with the queried owner address of the user access NFT. If the locally recovered user address is consistent with the queried owner address of the user access NFT, the signature information verification succeeds. If the locally recovered user address is not consistent with the queried owner address of the user access NFT, the signature information verification fails. In some embodiments of the present disclosure, the WiFi access point sends the recovered user address to the blockchain, and the blockchain returns the queried user access NFT ID corresponding to the user address to the WiFi access point. The WiFi access point compares the locally recovered user access NFT ID with the queried user access NFT ID. If the locally recovered user access NFT ID is consistent with the queried user access NFT ID, the signature information verification succeeds. If the locally recovered user access NFT ID is not consistent with the queried user access NFT ID, the signature information verification fails.

In step S1822, the WiFi access point returns a user authentication result based on the verification of the signature information to the user equipment of the WiFi user. If the signature information verification succeeds, the user authentication is passed. If the signature information verification fails, the user authentication is not passed. In step S1824, in a case where the user authentication is passed, the WiFi access point allows the user equipment of the WiFi user to access the Internet.

It should be noted that the communication between the WiFi access point and the blockchain described above actually goes through the TVWS terminal and the TVWS access point.

In embodiments of the present disclosure, user access control is performed based on NFT distribution and auction, and spectrum usage rights are transferred among users, thereby achieving control over and billing for access of end users. In addition, the auction can handle the problem of a plurality of users requesting allocation of the same spectrum resource.

The embodiments of the present disclosure can lease an NFT's usage duration to make a user who has obtained a usage right of the NFT use corresponding spectrum resources to access the network during the lease period, without changing the NFT's owner. regulator authorities no longer need to carry out spectrum allocation through lengthy auction processes, and instead, the transfer of spectrum usage rights may be directly performed via user access NFTs, thereby achieving more flexible spectrum pricing.

Embodiments of the present disclosure generate signature information using a private key, and send the signature information to the spectrum management apparatus or the WiFi access point for verification. The spectrum management apparatus or the WiFi access point ensures the accuracy and the security of user authentication by querying relevant information on the blockchain and comparing it with the locally recovered information. Through multi-party consensus, the NFT and its owner can be uniquely determined and cannot be tampered.

### Application Examples

The technology of the present disclosure can be applied to various products. A base station may be implemented as various types of computation devices, or it may be implemented as any type of evolved Node B (eNB), gNB, or TRP (Transmit Receive Point), such as a macro eNB/gNB and a small eNB/gNB. A small eNB/gNB may be an eNB/gNB that covers a cell smaller than a macro cell, such as a pico eNB/gNB, a micro eNB/gNB, and a home (femto) eNB/gNB. Instead, the base station may be implemented as any other types of base stations such as a NodeB and a base transceiver station (BTS). The base station may include a main body (also referred to as a base station device) configured to control wireless communication and one or more remote radio heads (RRHs) disposed at different locations from the main body. Additionally, various types of terminals to be discussed later may also operate as the base station by temporarily or semi-permanently executing a base station function.

A user equipment may be implemented as various types of computation devices, or may be implemented as a mobile terminal (such as a smartphone, a tablet personal computer (PC), a notebook PC, a portable game terminal, a portable/dongle mobile router and a digital camera), or an in-vehicle terminal (such as a car navigation device). The user equipment may further be implemented as a terminal that performs machine to machine (M2M) communication (also referred to as a machine type communication (MTC) terminal).

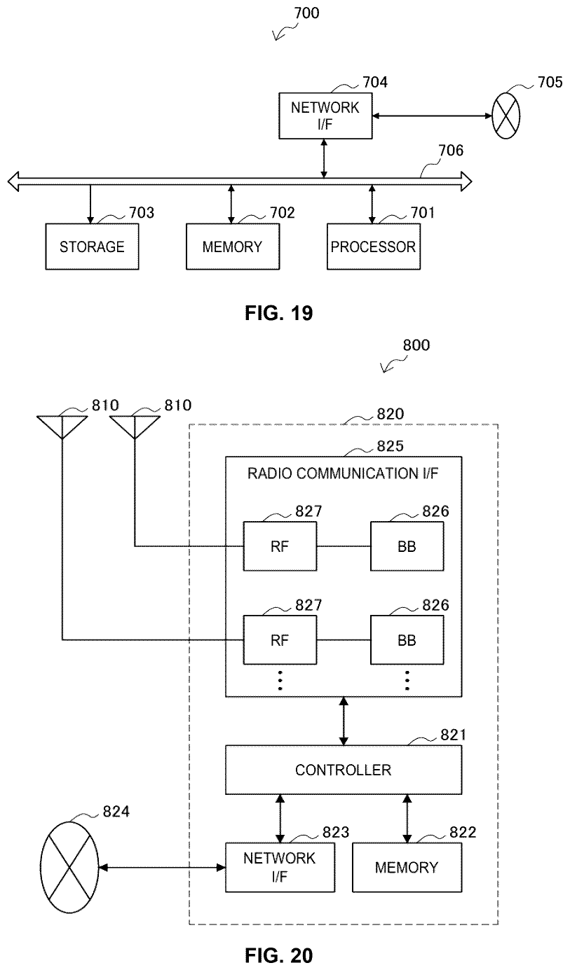

FIG. 19 is a block diagram illustrating an example of a schematic configuration of a computation device 700 to which the technology of the present disclosure may be applied. The computation device 700 includes a processor 701, a memory 702, a storage 703, a network I/F 704, and a bus 706.

The processor 701 may be, for example, a central processing unit (CPU) or a digital signal processor (DSP) and controls functions of the server 700. The memory 702 includes a random access memory (RAM) and a read only memory (ROM) and stores data and programs executed by the processor 701. The storage 703 may include a storage medium such as a semiconductor memory or a hard disk.

The network I/F 704 is a wired communication interface for connecting the server 700 to a wired communication network 705. The wired communication network 705 may be a core network such as an evolved packet core (EPC) or a packet data network (PDN) such as the Internet.

The bus 706 connects the processor 701, the memory 702, the storage 703, and the network I/F 704 to each other. The bus 706 may include two or more buses that operate at different speeds (e.g., a high-speed bus and a low-speed bus).

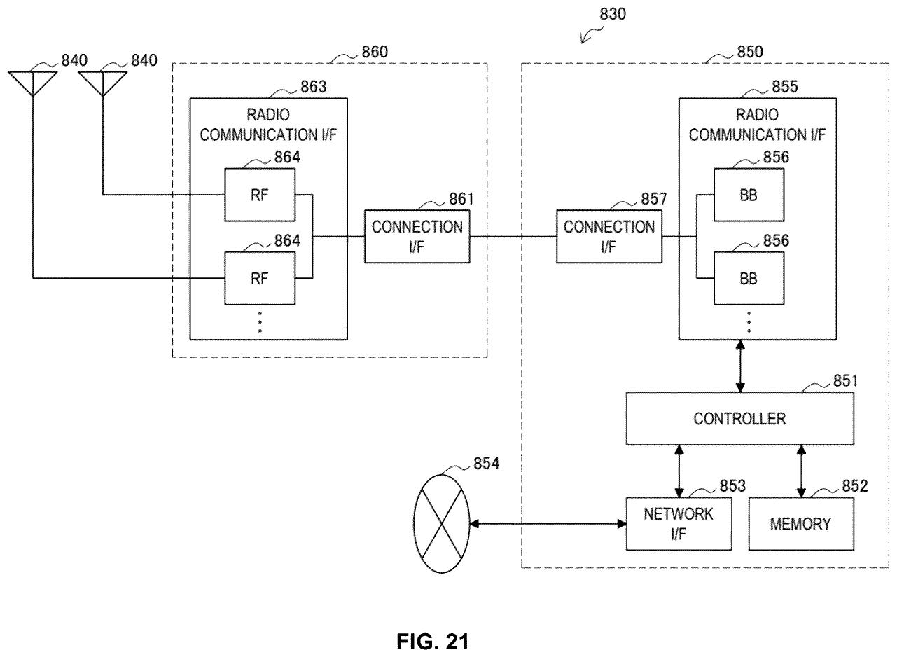

FIG. 20 is a block diagram illustrating a first example of a schematic configuration of a gNB to which the technology of the present disclosure may be applied. A gNB 800 includes one or more antennas 810 as well as a base station device 820. The base station device 820 and each antenna 810 may be connected to each other via an RF cable.

Each of the antennas 810 includes a single or multiple antenna elements (such as multiple antenna elements included in an multiple input multiple output (MIMO) antenna), and is used for the base station device 820 to transmit and receive wireless signals. The gNB 800 may include the multiple antennas 810, as illustrated in FIG. 20. For example, the multiple antennas 810 may be compatible with multiple frequency bands used by the gNB 800. Although FIG. 20 illustrates the example in which the gNB 800 includes the multiple antennas 810, the gNB 800 may also include a single antenna 810.

The base station device 820 includes a controller 821, a memory 822, a network I/F 823, and a radio communication I/F 825.

The controller 821 may be, for example, a CPU or a DSP, and operates various functions of a higher layer of the base station device 820. For example, the controller 821 generates a data packet from data in signals processed by the radio communication I/F 825, and transfers the generated packet via the network I/F 823. The controller 821 may bundle data from multiple base band processors to generate the bundled packet, and transfer the generated bundled packet. The controller 821 may have logical functions of performing control such as radio resource control, radio bearer control, mobility management, admission control, and scheduling. The control may be performed in corporation with an gNB or a core network node in the vicinity. The memory 822 includes RAM and ROM, and stores a program that is executed by the controller 821, and various types of control data (such as a terminal list, transmission power data, and scheduling data).

The network I/F 823 is a communication interface for connecting the base station device 820 to a core network 824. The controller 821 may communicate with a core network node or another gNB via the network I/F 823. In that case, the gNB 800, and the core network node or the other gNB may be connected to each other through a logical interface (such as an SI interface and an X2 interface). The network I/F 823 may also be a wired communication interface or a radio communication I/F for radio backhaul. If the network I/F 823 is a radio communication I/F, the network I/F 823 may use a higher frequency band for wireless communication than a frequency band used by the radio communication I/F 825.

The radio communication I/F 825 supports any cellular communication scheme such as Long Term Evolution (LTE) and LTE-Advanced, and provides radio connection to a terminal positioned in a cell of the gNB 800 via the antenna 810. The radio communication I/F 825 may typically include, for example, a baseband (BB) processor 826 and an RF circuit 827. The BB processor 826 may perform, for example, encoding/decoding, modulating/demodulating, and multiplexing/demultiplexing, and performs various types of signal processing of layers (such as L1, medium access control (MAC), radio link control (RLC), and a packet data convergence protocol (PDCP)). The BB processor 826 may have a part or all of the above-described logical functions instead of the controller 821. The BB processor 826 may be a memory that stores a communication control program, or a module that includes a processor and a related circuit configured to execute the program. Updating the program may allow the functions of the BB processor 826 to be changed. The module may be a card or a blade that is inserted into a slot of the base station device 820. Alternatively, the module may also be a chip that is mounted on the card or the blade. Meanwhile, the RF circuit 827 may include, for example, a mixer, a filter, and an amplifier, and transmits and receives wireless signals via the antenna 810.

The radio communication I/F 825 may include the multiple BB processors 826, as illustrated in FIG. 20. For example, the multiple BB processors 826 may be compatible with multiple frequency bands used by the gNB 800. The radio communication I/F 825 may include the multiple RF circuits 827, as illustrated in FIG. 20. For example, the multiple RF circuits 827 may be compatible with multiple antenna elements. Although FIG. 20 illustrates the example in which the radio communication I/F 825 includes the multiple BB processors 826 and the multiple RF circuits 827, the radio communication I/F 825 may also include a single BB processor 826 or a single RF circuit 827.

FIG. 21 is a block diagram illustrating a second example of a schematic configuration of a gNB to which the technology of the present disclosure may be applied. A gNB 830 includes one or more antennas 840, a base station device 850 and RRH 860. The RRH 860 and each antenna 840 may be connected to each other via an RF cable. The base station device 850 and the RRH 860 may be connected to each other via a high speed line such as an optical fiber cable.

Each of the antennas 840 includes a single or multiple antenna elements (such as multiple antenna elements included in an MIMO antenna) and is used for the RRH 860 to transmit and receive wireless signals. The gNB 830 may include the multiple antennas 840, as illustrated in FIG. 21. For example, the multiple antennas 840 may be compatible with multiple frequency bands used by the gNB 830. Although FIG. 21 illustrates the example in which the gNB 830 includes the multiple antennas 840, the gNB 830 may also include a single antenna 840.

The base station device 850 includes a controller 851, a memory 852, a network I/F 853, a radio communication I/F 855, and a connection I/F 857. The controller 851, the memory 852, and the network I/F 853 are the same as the controller 821, the memory 822, and the network I/F 823 described with reference to FIG. 20.

The radio communication I/F 855 supports any cellular communication scheme such as LTE and LTE-Advanced, and provides wireless communication to a terminal positioned in a sector corresponding to the RRH 860 via the RRH 860 and the antenna 840. The radio communication I/F 855 may typically include, for example, a BB processor 856. The BB processor 856 is the same as the BB processor 826 described with reference to FIG. 20, except the BB processor 856 is connected to the RF circuit 864 of the RRH 860 via the connection I/F 857. The radio communication I/F 855 may include the multiple BB processors 856, as illustrated in FIG. 21. For example, the multiple BB processors 856 may be compatible with multiple frequency bands used by the gNB 830. Although FIG. 21 illustrates the example in which the radio communication I/F 855 includes the multiple BB processors 856, the radio communication I/F 855 may also include a single BB processor 856.

The connection I/F 857 is an interface for connecting the base station device 850 (radio communication I/F 855) to the RRH 860. The connection I/F 857 may also be a communication module for communication in the above-described high speed line that connects the base station device 850 (radio communication I/F 855) to the RRH 860.

The RRH 860 includes a connection I/F 861 and a radio communication I/F 863.

The connection I/F 861 is an interface for connecting the RRH 860 (radio communication I/F 863) to the base station device 850. The connection I/F 861 may also be a communication module for communication in the above-described high speed line.

The radio communication I/F 863 transmits and receives wireless signals via the antenna 840. The radio communication I/F 863 may typically include, for example, the RF circuit 864. The RF circuit 864 may include, for example, a mixer, a filter, and an amplifier, and transmits and receives wireless signals via the antenna 840. The radio communication I/F 863 may include multiple RF circuits 864, as illustrated in FIG. 21. For example, the multiple RF circuits 864 may support multiple antenna elements. Although FIG. 21 illustrates the example in which the radio communication I/F 863 includes the multiple RF circuits 864, the radio communication I/F 863 may also include a single RF circuit 864.

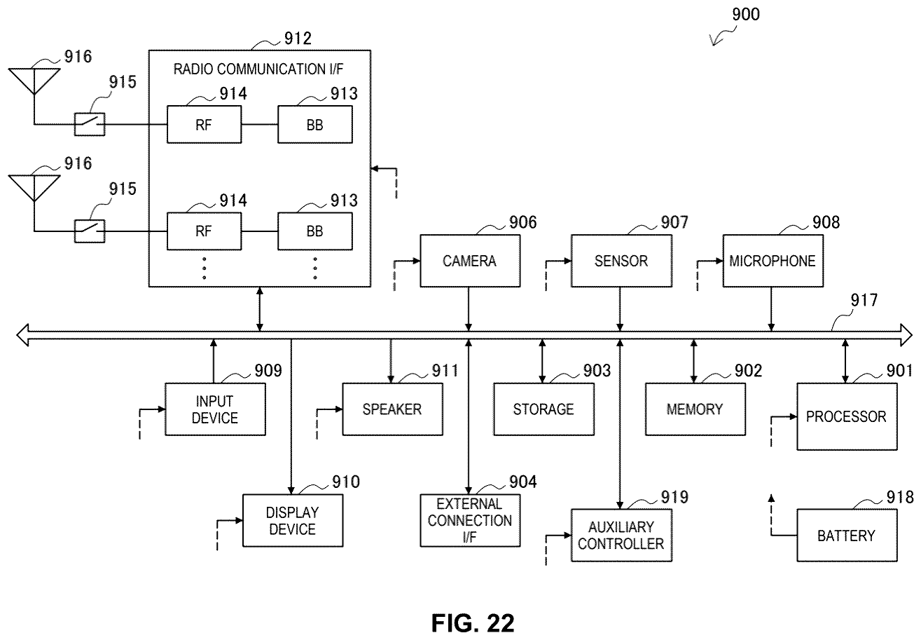

FIG. 22 is a block diagram illustrating an example of a schematic configuration of a smartphone 900 to which the technology of the present disclosure may be applied. The smartphone 900 includes a processor 901, a memory 902, a storage 903, an external connection I/F 904, a camera 906, a sensor 907, a microphone 908, an input device 909, a display device 910, a speaker 911, a radio communication I/F 912, one or more antenna switches 915, one or more antennas 916, a bus 917, a battery 918, and an auxiliary controller 919.

The processor 901 may be, for example, a CPU or a system on a chip (SoC), and controls functions of an application layer and another layer of the smartphone 900. The memory 902 includes RAM and ROM, and stores data and a program that is executed by the processor 901. The storage 903 may include a storage medium such as a semiconductor memory and a hard disk. The external connection I/F 904 is an interface for connecting an external device such as a memory card and a universal serial bus (USB) device to the smartphone 900.

The camera 906 includes an image sensor such as a charge coupled device (CCD) and a complementary metal oxide semiconductor (CMOS), and generates a captured image. The sensor 907 may include a group of sensors such as a measurement sensor, a gyro sensor, a geomagnetic sensor, and an acceleration sensor. The microphone 908 converts sounds that are input to the smartphone 900 to audio signals. The input device 909 includes, for example, a touch sensor configured to detect touch onto a screen of the display device 910, a keypad, a keyboard, a button, or a switch, and receives an operation or an information input from a user. The display device 910 includes a screen such as a liquid crystal display (LCD) and an organic light-emitting diode (OLED) display, and displays an output image of the smartphone 900. The speaker 911 converts audio signals that are output from the smartphone 900 to sounds.

The radio communication I/F 912 supports any cellular communication scheme such as LTE and LTE-Advanced, and performs wireless communication. The radio communication I/F 912 may typically include, for example, a BB processor 913 and an RF circuit 914. The BB processor 913 may perform, for example, encoding/decoding, modulating/demodulating, and multiplexing/demultiplexing, and performs various types of signal processing for wireless communication. Meanwhile, the RF circuit 914 may include, for example, a mixer, a filter, and an amplifier, and transmits and receives wireless signals via the antenna 916. The radio communication I/F 912 may be a one chip module that has the BB processor 913 and the RF circuit 914 integrated thereon. The radio communication I/F 912 may include the multiple BB processors 913 and the multiple RF circuits 914, as illustrated in FIG. 22. Although FIG. 22 illustrates the example in which the radio communication I/F 912 includes the multiple BB processors 913 and the multiple RF circuits 914, the radio communication I/F 912 may also include a single BB processor 913 or a single RF circuit 914.

Furthermore, in addition to a cellular communication scheme, the radio communication I/F 912 may support another type of wireless communication scheme such as a short-distance wireless communication scheme, a near field communication scheme, and a wireless local area network (LAN) scheme. In that case, the radio communication I/F 912 may include the BB processor 913 and the RF circuit 914 for each wireless communication scheme.

Each of the antenna switches 915 switches connection destinations of the antennas 916 among multiple circuits (such as circuits for different wireless communication schemes) included in the radio communication I/F 912.

Each of the antennas 916 includes a single or multiple antenna elements (such as multiple antenna elements included in an MIMO antenna), and is used for the radio communication I/F 912 to transmit and receive wireless signals. The smartphone 900 may include the multiple antennas 916, as illustrated in FIG. 22. Although FIG. 22 illustrates the example in which the smartphone 900 includes the multiple antennas 916, the smartphone 900 may also include a single antenna 916.

Furthermore, the smartphone 900 may include the antenna 916 for each wireless communication scheme. In that case, the antenna switches 915 may be omitted from the configuration of the smartphone 900.

The bus 917 connects the processor 901, the memory 902, the storage 903, the external connection I/F 904, the camera 906, the sensor 907, the microphone 908, the input device 909, the display device 910, the speaker 911, the radio communication I/F 912, and the auxiliary controller 919 to each other. The battery 918 supplies power to blocks of the smartphone 900 illustrated in FIG. 22 via feeder lines, which are partially shown as dashed lines in the figure. The auxiliary controller 919 operates a minimum necessary function of the smartphone 900, for example, in a sleep mode.

### Second Application Example

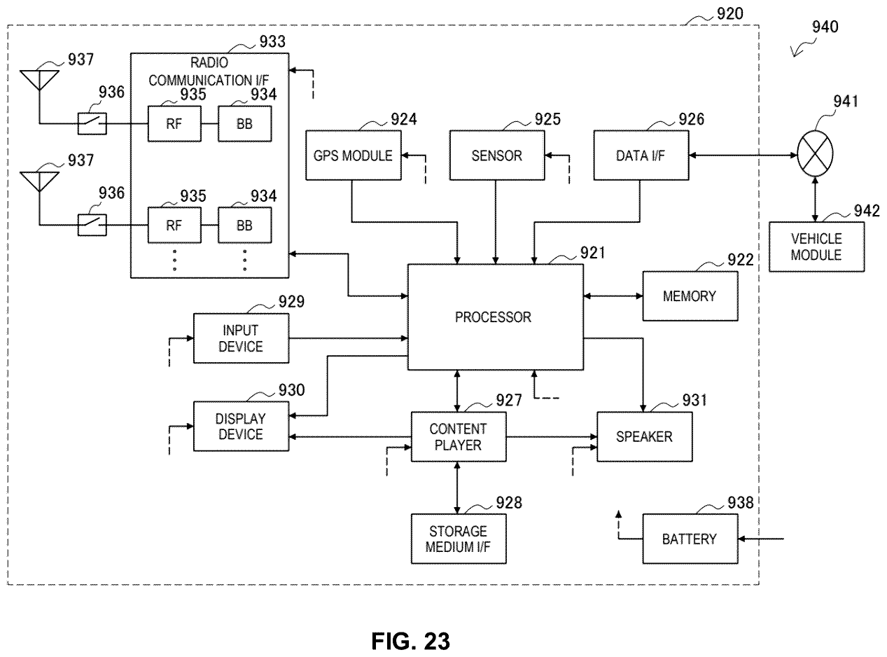

FIG. 23 is a block diagram illustrating an example of a schematic configuration of a car navigation device 920 to which the technology of the present disclosure may be applied. The car navigation device 920 includes a processor 921, a memory 922, a global positioning system (GPS) module 924, a sensor 925, a data interface 926, a content player 927, a storage medium I/F 928, an input device 929, a display device 930, a speaker 931, a radio communication I/F 933, one or more antenna switches 936, one or more antennas 937, and a battery 938.

The processor 921 may be, for example, a CPU or a SoC, and controls a navigation function and another function of the car navigation device 920. The memory 922 includes RAM and ROM, and stores data and a program that is executed by the processor 921.

The GPS module 924 uses GPS signals received from a GPS satellite to measure a position (such as latitude, longitude, and altitude) of the car navigation device 920. The sensor 925 may include a group of sensors such as a gyro sensor, a geomagnetic sensor, and a barometric sensor. The data interface 926 is connected to, for example, an in-vehicle network 941 via a terminal that is not shown, and acquires data generated by the vehicle, such as vehicle speed data.

The content player 927 reproduces content stored in a storage medium (such as a CD and a DVD) that is inserted into the storage medium I/F 928. The input device 929 includes, for example, a touch sensor configured to detect touch onto a screen of the display device 930, a button, or a switch, and receives an operation or an information input from a user. The display device 930 includes a screen such as a LCD or an OLED display, and displays an image of the navigation function or content that is reproduced. The speaker 931 outputs sounds of the navigation function or the content that is reproduced.

The radio communication I/F 933 supports any cellular communication scheme such as LET and LTE-Advanced, and performs wireless communication. The radio communication I/F 933 may typically include, for example, a BB processor 934 and an RF circuit 935. The BB processor 934 may perform, for example, encoding/decoding, modulating/demodulating, and multiplexing/demultiplexing, and performs various types of signal processing for wireless communication. Meanwhile, the RF circuit 935 may include, for example, a mixer, a filter, and an amplifier, and transmits and receives wireless signals via the antenna 937. The radio communication I/F 933 may also be a one chip module having the BB processor 934 and the RF circuit 935 integrated thereon. The radio communication I/F 933 may include the multiple BB processors 934 and the multiple RF circuits 935, as illustrated in FIG. 23. Although FIG. 23 illustrates the example in which the radio communication I/F 933 includes the multiple BB processors 934 and the multiple RF circuits 935, the radio communication I/F 933 may also include a single BB processor 934 or a single RF circuit 935.

Furthermore, in addition to a cellular communication scheme, the radio communication I/F 933 may support another type of wireless communication scheme such as a short-distance wireless communication scheme, a near field communication scheme, and a wireless LAN scheme. In that case, the radio communication I/F 933 may include the BB processor 934 and the RF circuit 935 for each wireless communication scheme.

Each of the antenna switches 936 switches connection destinations of the antennas 937 among multiple circuits (such as circuits for different wireless communication schemes) included in the radio communication I/F 933.

Each of the antennas 937 includes a single or multiple antenna elements (such as multiple antenna elements included in an MIMO antenna), and is used for the radio communication I/F 933 to transmit and receive wireless signals. The car navigation device 920 may include the multiple antennas 937, as illustrated in FIG. 23. Although FIG. 23 illustrates the example in which the car navigation device 920 includes the multiple antennas 937, the car navigation device 920 may also include a single antenna 937.

Furthermore, the car navigation device 920 may include the antenna 937 for each wireless communication scheme. In that case, the antenna switches 936 may be omitted from the configuration of the car navigation device 920.

The battery 938 supplies power to blocks of the car navigation device 920 illustrated in FIG. 23 via feeder lines that are partially shown as dashed lines in the figure. The battery 938 accumulates power supplied from the vehicle.

The technology of the present disclosure may also be realized as an in-vehicle system (or a vehicle) 940 including one or more blocks of the car navigation device 920, the in-vehicle network 941, and a vehicle module 942. The vehicle module 942 generates vehicle data such as vehicle speed, engine speed, and trouble information, and outputs the generated data to the in-vehicle network 941.

Various schematic blocks and components described in conjunction with the present disclosure may be implemented or executed by general-purpose processors, digit signal processors (DSPs), ASICs, FPGAs or other programmable logic devices, discrete gates or transistor logics, discrete hardware components or any combination thereof, which are designed to execute functions described herein. The general-purpose processor may be a microprocessor, but instead, the processor may be any conventional processor, controller, microcontroller and/or state machine. The processor may also be implemented as a combination of computation devices, e.g. a DSP and a microprocessor, a plurality of microprocessors, one or more microprocessors in conjunction with a DSP core and/or any other combinations of such configurations.

Functions described herein may be implemented in hardware, software executed by a processor, firmware or any combination thereof. If implemented in software executed by the processor, the functions may be stored on a non-transitory computer-readable medium or transmitted as one or more instructions or codes on a non-transitory computer-readable medium. Other examples and implementations are within the scope and spirit of the present disclosure and the appended claims. For example, in view of the essence of software, the above described functions may be executed by using software executed by the processor, hardware, firmware, hard-wire or any combination of these. Feature to achieve the functions may also be located in various positions physically, including being distributed such that parts of the functions are implemented in different physical positions.

In addition, disclosure of a component which is contained in other components or separated from other components should be deemed to be exemplary, because potentially it is possible to implement various other architectures to achieve the same function, including incorporating all, a major part of, and/or some elements as one or more single structures or a part of a separate structure.

The non-transitory computer-readable medium may be any usable non-transitory medium which can be accessed by a general-purpose computer or a special-purpose computer. By way of example, and not limitation, the non-transitory computer-readable media may comprise RAM, ROM, EEPROM, flash memory, CD-ROM, DVD or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor.

The foregoing description of the present disclosure is provided to enable those skilled in the art to make or use the present disclosure. Various modifications to the present disclosure are obvious to those skilled in the art, general principles defined herein may be applied to other modifications without departing from the scope the present disclosure. Therefore, the present disclosure is not limited to examples and designs described herein, but corresponds to the broadest scope consistent with the disclosed principles and new features.

In some embodiments of the present disclosure, the processing in the base station and/or the user equipment may be executed by itself or components thereof (for example, such as an electronic device of a chip). The electronic device may include a processing circuitry. The processing circuitry may output a signal (digital or analog) to other components in the base station and/or the user equipment, may also receive a signal (digital or analog) from other components in the base station and/or the user equipment. In addition, the processing circuitry may also control a part or all of operations of other components in the base station and/or the user equipment.

The processing circuitry may be in the form of a general-purpose processor, may also be a special-purpose processing circuitry, e.g. ASIC. For example, the processing circuitry can be configured by circuitry (hardware) or a central processing device (such as, a Central Processing Unit (CPU)). In addition, the processing circuitry may bear program (software) for causing the circuitry (hardware) or the central processing device to work. The program can be stored in a memory (such as, arranged in a distributed node and/or the central processing apparatus or the electronic device) or an external storage medium externally connected, or downloaded via a network (such as, Internet).

In addition, the present disclosure further includes embodiments as follows.

1. An electronic device comprising processing circuitry configured to:
receive a spectrum request from a spectrum request system;
send heartbeat interval information to the spectrum request system, the heartbeat interval information indicating a heartbeat interval at which the spectrum request system sends heartbeat requests, and the heartbeat interval information being shortest spectrum occupation time predicted based on spectrum usage data of the spectrum request system.

2. The electronic device of embodiment 1, wherein the processing circuitry is further configured to:
generate Non-Fungible Tokens (NFTs) for available spectrum resources;
perform a spectrum trading process on the spectrum request based on the NFTs in a blockchain network, to generate one or more NFT-based spectrum trading schemes; and
authenticate the one or more spectrum trading schemes.

3. The electronic device of embodiment 2, wherein the processing circuitry is further configured to package a spectrum trading scheme, which passes the authentication, of the one or more spectrum trading schemes into a new block, and add it to a blockchain.

4. The electronic device of embodiment 2 or 3, wherein the electronic device operates as a full node or an accounting node in the blockchain network, and the spectrum request system operates as a light node in the blockchain network.

5. The electronic device of embodiment 4, wherein the full node or the accounting node locally stores the spectrum usage data of the spectrum request system.

6. The electronic device of embodiment 1, wherein the processing circuitry is further configured to predict the shortest spectrum occupation time based on the spectrum usage data of the spectrum request system.

7. The electronic device of embodiment 1, wherein the processing circuitry is further configured to train a prediction model for predicting the shortest spectrum occupation time.

8. The electronic device of embodiment 7, wherein the prediction model is obtained through federated learning.

9. The electronic device of embodiment 1, wherein the processing circuitry is further configured to:
send the spectrum usage data of the spectrum request system to a prediction apparatus; and
receive the shortest spectrum occupation time predicted based on the spectrum usage data of the spectrum request system from the prediction apparatus.

10. The electronic device of embodiment 9, wherein the prediction apparatus operates as at least one of a computing platform or a Network Data Analytics Function (NWDAF) of a 5G core network (5GC).

11. The electronic device of embodiment 1, wherein the processing circuitry is further configured to receive the heartbeat requests based on the heartbeat interval from the spectrum request system.

12. An electronic device at a spectrum request system comprising processing circuitry configured to:
acquire heartbeat interval information, the heartbeat interval information indicating a heartbeat interval at which the spectrum request system sends heartbeat requests, and the heartbeat interval information being shortest spectrum occupation time predicted based on spectrum usage data of the spectrum request system; and
send the heartbeat requests based on the heartbeat interval to a spectrum management apparatus.

13. The electronic device of embodiment 12, wherein the spectrum request system operates as one of a light node, a full node or an accounting node in a blockchain network.

14. The electronic device of embodiment 12, wherein the spectrum request system operates as a full node in a blockchain network, and the processing circuitry is further configured to:
generate Non-Fungible Tokens (NFTs) for available spectrum resources;
perform a spectrum trading process on the spectrum request based on the NFTs in the blockchain network, to generate one or more NFT-based spectrum trading schemes;
authenticate the one or more spectrum trading schemes.

15. The electronic device of embodiment 12, wherein acquiring the heartbeat interval information comprises:
predict the shortest spectrum occupation time based on the spectrum usage data of the spectrum request system; or
receive the predicted shortest spectrum occupation time from other nodes in the spectrum request system or an external computing platform.

16. An electronic device comprising processing circuitry configured to:
acquire spectrum usage data of a spectrum request system; and
send shortest spectrum occupation time predicted based on the spectrum usage data of the spectrum request system as a heartbeat interval of the spectrum request system.

17. The electronic device of embodiment 16, wherein the processing circuitry is further configured to predict the shortest spectrum occupation time based on the spectrum usage data of the spectrum request system.

18. The electronic device of embodiment 16, wherein the processing circuitry is further configured to train a prediction model for predicting the shortest spectrum occupation time.

19. The electronic device of embodiment 18, wherein the prediction model is obtained through federated learning.

20. An electronic device for user access control comprising processing circuitry configured to:
receive signature information from a user's user equipment, the signature information being generated based on the user's user address and a user access non-fungible token (NFT) ID;
verify the received signature information on a blockchain;
send a user authentication result based on the verification of the signature information to the user equipment; and
in response to user authentication is passed, allow the user equipment to access Internet.

21. The electronic device of embodiment 20, wherein verifying the received signature information on the blockchain comprises:
recover the user address and the user access NFT ID from the received signature information;
query an owner address of a user access NFT corresponding to the user access NFT ID on the blockchain;
verify whether the recovered user address and the queried owner address of the user access NFT are consistent.

22. The electronic device of embodiment 21, wherein the signature information is generated by encrypting the user address and the user access NFT ID with the user's private key, and recovering the user address and the user access NFT ID from the received signature information includes decrypting the received signature information with a public key.

23. The electronic device of embodiment 20, wherein the processing circuitry is further configured to:
generate a user access NFT;
send the user access NFT ID to the user who requests access;
set up an auction for a lease duration of the user access NFT;
when the user succeeds in the auction, set an owner address of the user access NFT to the user's user address.

24. The electronic device of embodiment 23, wherein the processing circuitry is further configured to reset the owner address of the user access NFT when the lease duration of the user access NFT expires.

25. The electronic device of embodiment 20, wherein the electronic device operates as a WiFi access point or a spectrum management apparatus.

26. An electronic device for a user equipment comprising processing circuitry configured to:
after connecting to an access point, send signature information to the access point, the signature information being generated based on a user's user address and a user access non-fungible token (NFT) ID;
receive a user authentication result from the access point;
in a case where user authentication is passed, access Internet.

27. The electronic device of embodiment 26, wherein the signature information is generated by encrypting the user address and the user access NFT ID with the user's private key.

28. The electronic device of embodiment 26, wherein the processing circuitry is further configured to:
participate in an auction for a lease duration of a user access NFT.

29. The electronic device of embodiment 26, wherein the processing circuitry is further configured to:
generate the signature information based on the user's user address and the user access NFT ID.

30. A method of determining a heartbeat interval of a spectrum request system, comprising:
receive a spectrum request from the spectrum request system; and
send heartbeat interval information to the spectrum request system, the heartbeat interval information indicating a heartbeat interval at which the spectrum request system sends heartbeat requests, and the heartbeat interval information being shortest spectrum occupation time predicted based on spectrum usage data of the spectrum request system.

31. A method of determining a heartbeat interval of a spectrum request system, comprising:
acquire heartbeat interval information, the heartbeat interval information indicating a heartbeat interval at which the spectrum request system sends heartbeat requests, and the heartbeat interval information being shortest spectrum occupation time predicted based on spectrum usage data of the spectrum request system; and
send the heartbeat requests based on the heartbeat interval to a spectrum management apparatus.

32. A method of determining a heartbeat interval of a spectrum request system, comprising:
acquire spectrum usage data of the spectrum request system; and
send shortest spectrum occupation time predicted based on the spectrum usage data of the spectrum request system as the heartbeat interval of the spectrum request system.

33. A non-transitory computer-readable storage medium with program instructions stored thereon, which when executed by a processor cause the processor to perform the method of any of claims 30 to 32.

34. A computer program product including program instructions, which when executed by a processor cause the processor to perform the method of any of claims 30 to 32.

1. An electronic device comprising processing circuitry configured to:
receive a spectrum request from a spectrum request system;
send heartbeat interval information to the spectrum request system, the heartbeat interval information indicating a heartbeat interval at which the spectrum request system sends heartbeat requests, and the heartbeat interval information being shortest spectrum occupation time predicted based on spectrum usage data of the spectrum request system.

2. The electronic device of claim 1, wherein the processing circuitry is further configured to:
generate Non-Fungible Tokens (NFTs) for available spectrum resources;
perform a spectrum trading process on the spectrum request based on the NFTs in a blockchain network, to generate one or more NFT-based spectrum trading schemes; and
authenticate the one or more spectrum trading schemes.

3. The electronic device of claim 2, wherein the processing circuitry is further configured to package a spectrum trading scheme, which passes the authentication, of the one or more spectrum trading schemes into a new block, and add it to a blockchain.

4. The electronic device of claim 2, wherein the electronic device operates as a full node or an accounting node in the blockchain network, and the spectrum request system operates as a light node in the blockchain network.

5. The electronic device of claim 4, wherein the full node or the accounting node locally stores the spectrum usage data of the spectrum request system.

6. The electronic device of claim 1, wherein the processing circuitry is further configured to predict the shortest spectrum occupation time based on the spectrum usage data of the spectrum request system.

7. The electronic device of claim 1, wherein the processing circuitry is further configured to train a prediction model for predicting the shortest spectrum occupation time.

8. The electronic device of claim 7, wherein the prediction model is obtained through federated learning.

9. The electronic device of claim 1, wherein the processing circuitry is further configured to:
send the spectrum usage data of the spectrum request system to a prediction apparatus; and
receive the shortest spectrum occupation time predicted based on the spectrum usage data of the spectrum request system from the prediction apparatus.

10. The electronic device of claim 9, wherein the prediction apparatus operates as at least one of a computing platform or a Network Data Analytics Function (NWDAF) of a 5G core network (5GC).

11. The electronic device of claim 1, wherein the processing circuitry is further configured to receive the heartbeat requests based on the heartbeat interval from the spectrum request system.

12. An electronic device at a spectrum request system comprising processing circuitry configured to:
acquire heartbeat interval information, the heartbeat interval information indicating a heartbeat interval at which the spectrum request system sends heartbeat requests, and the heartbeat interval information being shortest spectrum occupation time predicted based on spectrum usage data of the spectrum request system; and
send the heartbeat requests based on the heartbeat interval to a spectrum management apparatus.

13. The electronic device of claim 12, wherein the spectrum request system operates as one of a light node, a full node or an accounting node in a blockchain network.

14. The electronic device of claim 12, wherein the spectrum request system operates as a full node in a blockchain network, and the processing circuitry is further configured to:
generate Non-Fungible Tokens (NFTs) for available spectrum resources;
perform a spectrum trading process on the spectrum request based on the NFTs in the blockchain network, to generate one or more NFT-based spectrum trading schemes;
authenticate the one or more spectrum trading schemes.

15. The electronic device of claim 12, wherein acquiring the heartbeat interval information comprises:
predict the shortest spectrum occupation time based on the spectrum usage data of the spectrum request system; or
receive the predicted shortest spectrum occupation time from other nodes in the spectrum request system or an external computing platform.

16. An electronic device comprising processing circuitry configured to:
acquire spectrum usage data of a spectrum request system; and
send shortest spectrum occupation time predicted based on the spectrum usage data of the spectrum request system as a heartbeat interval of the spectrum request system.

17. The electronic device of claim 16, wherein the processing circuitry is further configured to predict the shortest spectrum occupation time based on the spectrum usage data of the spectrum request system.

18. The electronic device of claim 16, wherein the processing circuitry is further configured to train a prediction model for predicting the shortest spectrum occupation time.

19. The electronic device of claim 18, wherein the prediction model is obtained through federated learning.

20-34. (canceled)
